(19) United States
(12) Patent Application Publication
(10) Pub. No.: US 2022/0033073 A1
(43) Pub. Date: Feb. 3, 2022

(54) Image Capture and Obstacle Detection Assembly Intended to be Mounted on a Platform Such as a Drone and Drone Provided with Such an Image Capture and Obstacle Detection Assembly

(71) Applicant: Parrot Drones, Paris (FR)

(72) Inventors: Henri Seydoux Fornier de Clausonne, Paris (FR); Thomas Barse, Paris (FR)

(21) Appl. No.: 17/365,186

(22) Filed: Jul. 1, 2021

(30) Foreign Application Priority Data
Jul. 2, 2020 (FR) 2006994

(51) Int. Cl. B64C 39/02; B64D 47/08; G08G 5/00

(52) U.S. Cl. CPC B64C 39/024; B64C 2201/127; G08G 5/0069; B64D 47/08

(57) ABSTRACT

The image capture and obstacle detection assembly comprises a support device intended to be mounted on a platform, for example a drone, an image capture unit comprising at least one camera for capturing images and an obstacle detection unit comprising at least one obstacle sensor, the image capture unit and the obstacle detection unit being carried by the support device, the support device being configured such that the image capture unit is rotatable about at least one rotation axis and the obstacle detection unit is rotatable about at least one rotation axis.

### CROSS-REFERENCE TO RELATED APPLICATIONS

This application claims the benefit of FR 20 06994 filed on Jul. 2, 2020, which is incorporated herein by reference in its entirety.

### TECHNICAL FIELD

The present invention relates to an image capture and obstacle detection assembly intended to be mounted on a platform, for example on a drone, for image capture and obstacle detection.

### BACKGROUND

Small drones (also called “micro-drones”) for professional or recreational use, are generally equipped with a camera for capturing images for making photographs and videos.

When designing such drones, the objectives are generally to have a camera that can take very good quality images, to have the longest possible flight time, to limit the weight of the drone to facilitate its use and to comply with current legislation (the weight of mini-drones is limited to 900 grams under current European legislation), to facilitate its transport, for example by providing a foldable drone, and to limit the market price.

The camera is generally carried by a orientable support (generally called “gimbal”) mounted on the drone, the orientable support enabling the camera to be oriented in relation to the drone around three perpendicular axes, in order to point the camera in a desired direction.

In addition, it is sometimes desired that the drone can perform autonomous flights, i.e. without being remotely piloted by a human. This requires the drone to be able to detect and avoid obstacles.

To do so, the drone is equipped with an obstacle detection system for example, comprising a plurality of obstacle sensors, each obstacle sensor being fixedly mounted on the drone, the obstacle sensors being oriented in different directions in order to detect the obstacles all around the drone according to the direction of flight of the drone.

Analysis of the data provided by the obstacle sensors enables detection of the presence of obstacles. The obstacle sensors are image sensors for example, analysis of the images enabling the environment of the drone to be reconstructed in three dimensions.

However, the field of detection of these fixed obstacle sensors can be partly obstructed by elements of the drone, in particular by a camera carried by an adjustable support.

Moreover, multiplying the obstacle sensors increases the number of cables necessary for their connection, which complicates and weighs down the drone, and requires the provision of an electronic data processing unit that is sufficiently powerful to acquire and process the data provided by all the obstacle sensors.

To limit the problem of the obstruction of the detection field of the obstacle sensors, when the drone has a rotary wing and has arms at the ends of which rotors are arranged, it is possible to arrange obstacle sensors at the ends of these arms.

However, this imposes the provision of cables, extending along the arms to connect the obstacle sensors to the data processing unit, to dimension the more strongly arms to support the weight of the obstacle sensors and the cables in addition to that of the rotors, and prevents the provision of folding arms to facilitate storage of the drone.

In addition, the provision of multiple fixed obstacle sensors spread across the drone requires careful alignment of the obstacle sensors with each other, which makes the drone design and manufacture more complicated. Moreover, any shock suffered by the drone is likely to misalign one or more of the obstacle sensors, which makes the drone fragile.

In any case, the provision of a plurality of obstacle sensors oriented in different directions is inefficient, since, at any given time, only the signals provided by a part of the obstacle sensors are useful, namely the obstacle sensors whose detection field is oriented in the direction of flight of the drone at the considered time.

FR3087134A1 discloses a drone equipped with an observation camera for capturing images and a unit for detection of an obstacle by stereovision, the obstacle detection unit being mounted on the drone via a motorized orientable support, enabling the obstacle detection unit to be oriented in relation to the drone, and in particular to orient a sighting axis of the obstacle detection unit in the drone's flight direction. This enables the number of sensors dedicated to obstacle detection to be limited.

The drone can implement a detection algorithm to determine a three-dimensional mapping of the drone's environment from an analysis of the images provided by the stereovision cameras, and an avoidance algorithm to adapt the drone's trajectory according to the detected obstacles.

### SUMMARY OF THE INVENTION

One of the aims of the invention is to be able to obtain a drone that is equipped with an image capture unit and an obstacle detection unit, while being of simple design and limiting the risks of obstruction of a field of vision of the image capture unit and a detection field of the obstacle detection unit.

To this end, the invention proposes an image capture and obstacle detection assembly comprising a support device intended to be mounted on a platform, for example a drone, an image capture unit comprising at least one camera for capturing images and an obstacle detection unit comprising at least one obstacle sensor, the image capture unit and the obstacle detection unit being carried by the support device, the support device being configured such that the image capture unit is rotatable about at least one rotation axis and the obstacle detection unit is rotatable about at least one rotation axis.

The image capture and obstacle detection assembly comprising the image capture unit and the obstacle detection unit carried by the same support device, by each being orientable about at least one rotation axis in relation to the platform, makes it possible to limit the risks of obstruction for the image capture unit and/or for the obstacle detection unit, while simplifying the drone, since a single support device is used to carry the image capture unit and the obstacle detection unit.

According to particular embodiments, the image capture and obstacle detection assembly comprises one or more of the following optional features, taken individually or in any technically possible combination:
the image capture unit is rotatable about three mutually perpendicular rotation axes;
the image capture unit comprises a single camera;
the obstacle detection unit can be oriented around a single rotation axis;
each obstacle sensor is oriented perpendicular to the rotation axis and located at a distance from the rotation axis, so that when the rotation axis is horizontal, the obstacle detection unit is orientable in a position in which each obstacle sensor is oriented horizontally in one direction by being located lower than the rotation axis and a position in which each obstacle sensor is oriented horizontally in a second direction opposite to the first direction, by being located higher than the rotation axis;
one rotation axis of the image capturing unit and one rotation axis of the obstacle detecting unit are parallel to each other;
said parallel rotation axes are merged and define a common rotation axis, both the image capturing unit and the obstacle detecting unit being rotatable about this common rotation axis;
the image capture unit and the obstacle detection unit are rotatable relative to each other about the common rotation axis;
the obstacle detection unit comprises two obstacle detection sensors spaced along the common rotation axis, the image capture unit being located between the two obstacle sensors;
each sensor of the obstacle detection unit is carried by a support member rotatably mounted about the common rotation axis, the image capture unit being rotatable about the common rotation axis by pivoting about the support member;
the image capture unit is carried by an articulated bracket having an aperture, the support member extending through the aperture;
the articulated bracket comprises an actuator for controlling the orientation of the image capture unit about the common rotation axis, the aperture extending through the actuator;
the support device is provided with damping attachment assemblies configured to attach the support device to the platform, each attachment assembly comprising a damper adapted to abut the platform when the support device is mounted on the platform;
each damper is made of elastomeric material;
each damper is arranged to abut the platform along a bearing axis, the support device comprising three dampers whose bearing axes are not parallel to the same plane;
the support device comprises a mounting part for mounting the support device, the mounting part comprising a base and two side arms extending from the base, the obstacle detection unit being positioned between the free ends of the two side arms and carried by the two side arms;
the mounting member comprises at least one intermediate arm, each intermediate arm extending from the base and being located between the two side arms, the image capture unit being carried by each intermediate arm; and
the image capture unit is mounted on an intermediate arm via a sleeve through which the obstacle detection unit passes.

The invention also relates to a drone provided with an image capture and obstacle detection assembly as defined above, the drone comprising a capture module for controlling the orientation of the image capture unit relative to the drone and a detection module for controlling the orientation of the obstacle detection unit relative to the drone.

According to particular embodiments, the drone comprises one or more of the following optional features, taken individually or in any technically possible combination:
the common rotation axis is parallel to the pitch axis of the drone;
the other two rotation axes of the image capture unit are parallel to the yaw axis of the drone and to the roll axis of the drone, when the drone is hovering or landing on a horizontal surface and the image capture unit is oriented horizontally forward;
the image capture and obstacle detection assembly has an active configuration in which the image capture unit is carried by the support device in front of the common rotation axis, and a rest configuration in which the image capture unit is pivoted about the common rotation axis so as to be carried behind the common rotation axis;
the support device has a support member arranged to support the image capture unit in the rest configuration;
the control module is configured to switch to the rest configuration upon detection of a shock to the drone or a fall of the drone;
   the image capture and obstacle detection assembly is mounted at a front end of the drone body, at a position raised in relation to a rear part of the drone body;
the drone body having a front part and a rear part, the front part being elevated relative to the rear part
the detection module is configured to control the orientation of the obstacle detection unit so as to orient it substantially in the flight direction of the drone; and
it comprises an autopilot module, the autopilot module and the detection module being configured to pilot the drone and orient the obstacle detection unit so as to maintain the flight direction of the drone within the detection field of the obstacle detection unit with a non-zero angular margin between the flight direction and the edges of the detection field.

### BRIEF DESCRIPTION OF THE DRAWINGS

The invention and its advantages will be better understood upon reading the following description, given only as a non-limiting example, and made with reference to the attached drawings.

FIG. 1 is a top view of a drone equipped with an image capture and obstacle detection assembly.

FIG. 2 is a side view of the drone.

FIG. 3 is an analogous view to FIG. 1, with an image capture unit oriented differently.

FIG. 4 is an exploded front view of the image capture and obstacle detection assembly.

FIG. 5 is an exploded perspective view of the image capture and obstacle detection assembly.

FIG. 6 is an assembled perspective view of the image capture and obstacle detection assembly.

FIG. 7 is a view similar to FIG. 1, illustrating a flight configuration of the drone.

FIGS. 8 through 11 are side views of the drone in different flight configurations.

### DETAILED DESCRIPTION OF PREFERRED EMBODIMENTS

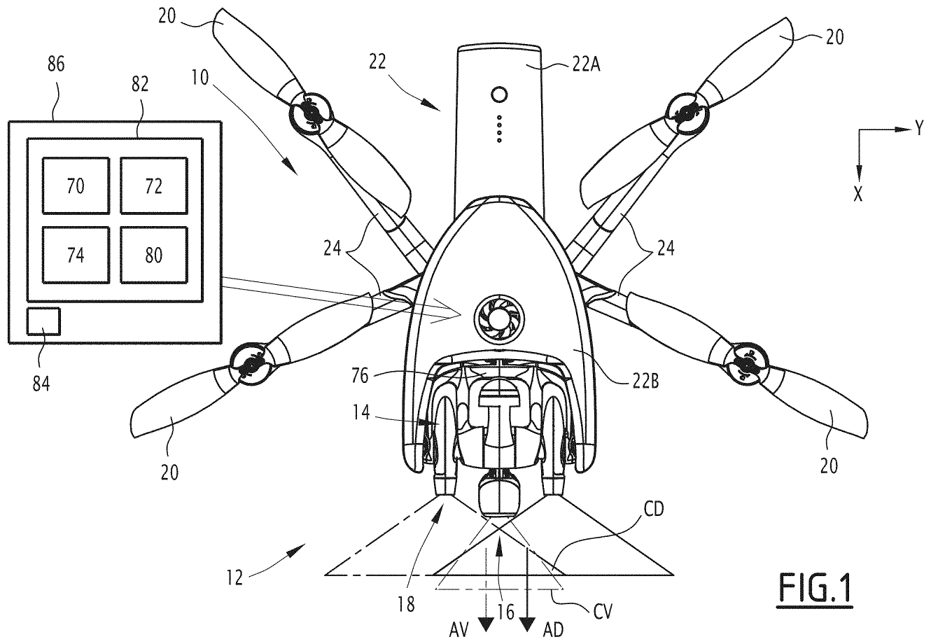

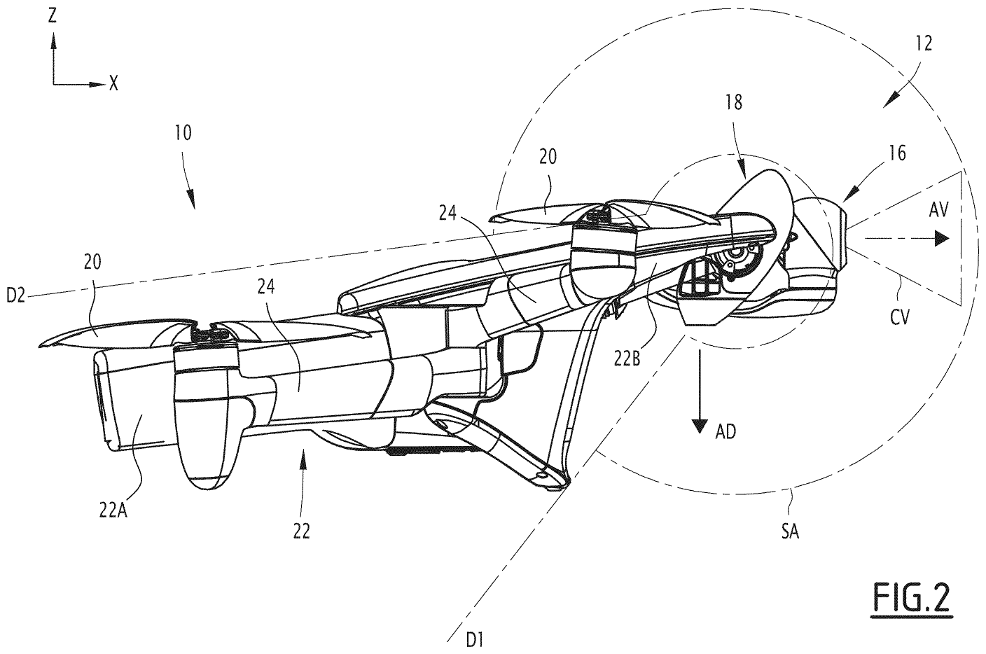

In FIGS. 1 and 2, a drone 10 is equipped with an image capture and obstacle detection assembly 12 (hereinafter “capture and detection assembly 12”) comprising a support device 14 mounted on the drone 10 and carrying an image capture unit 16 and an obstacle detection unit 18.

The drone 10 is an aircraft without a human pilot on board, self-piloted or remotely controllable, for example via a remote-control device, which can be done for example via smartphone, an electronic tablet or a joystick comprising for example at least one mobile control member, for example a control lever (or “joystick”), a rotary knob, a cursor, etc.

The drone 10 is a rotary wing drone and includes at least one rotor 20 to ensure the vertical lift of the drone 10. In FIGS. 1 and 2, the drone 10 includes a plurality of rotors 20, and is then called a “multi-rotor” drone. The number of rotors 20 is equal to four for example, and the drone 10 is then called a “quadrotor” drone.

The drone 10 conventionally has an orthogonal reference frame with a roll axis X, a pitch axis Y and a yaw axis Z. When the drone 10 is hovering or landing on a horizontal surface, the roll axis X is directed horizontally from back to front, the pitch axis Y is directed horizontally from right to left, and the yaw axis Z is directed vertically from bottom to top.

The drone 10 has a drone body 22 having a front part 22A and a rear part 22B.

The drone 10 has support arms 24, each support arm 24 extending from the drone body 22 and carrying a respective rotor 20 at an end of the support arm 24 opposite the drone body 22.

The image capture unit 16 and the obstacle detection unit 18 are separate.

The image capture unit 16 is configured to capture images, in particular to take photographs and/or videos. The image capture unit 16 has an observation axis AV, which is the axis along which the image capture unit 16 is oriented, and field of vision CV, which is the area of space seen by the image capture unit 16 when in a given orientation. The image capture unit 16 comprises an observation camera 26, for example, in particular a single observation camera 26. Each observation camera 26 is a rolling shutter camera, for example.

The obstacle detection unit 18 is configured to detect obstacles. The obstacle detection unit 18 comprises at least one obstacle sensor 28, and in particular two obstacle sensors 28. The obstacle detection unit 18 has a detection axis AD, which is the axis along which the obstacle detection unit 18 is oriented, and a detection field CD, which is the area of space in which the obstacle detection unit 18 is able to detect obstacles when in a given orientation.

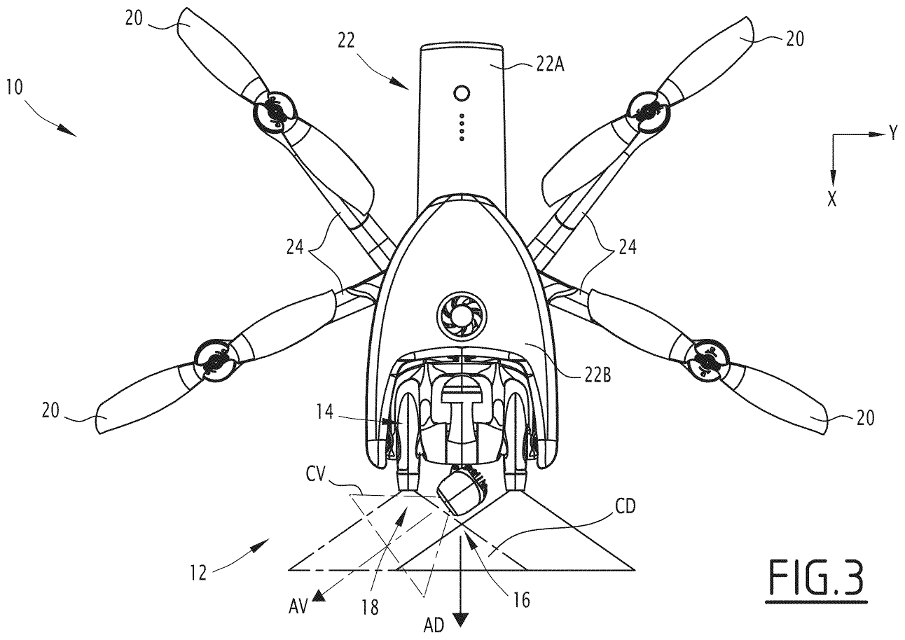

Each obstacle sensor 28 is, for example, a camera, the two obstacle sensors 28 being oriented along sensor axes parallel to the detection axis AD, while being spaced apart from each other so as to take images of the same scene with an offset between the images, the offset corresponding to the spacing between the two obstacle sensors 28. By analyzing the images of the same scene taken by the two obstacle sensors 28, a three-dimensional reconstruction of the scene can be recalculated. The obstacle detection unit 18 comprising such obstacle sensors 28 defines a stereovision system. As visible in FIG. 3, the detection field CD of the obstacle detection unit 18 is the overlap area of the fields of view of the two obstacle sensors 28 provided in the form of detection cameras.

Preferably, the obstacle sensors 28 provided in the form of cameras are global shutter cameras. This enables accurate images to be taken despite the rapid movement of the drone 10, for reliable obstacle detection.

The support device 14 is configured to be mounted on the drone 10. The support device 14 carries both the image capture unit 16 and the obstacle detection unit 18, while being configured to enable orientation of the image capture unit 16 about at least one rotation axis and to enable orientation of the obstacle detection unit 18 about at least one rotation axis.

Preferably, the support device 14 is configured such that the image capture unit 16 can pivot about each rotation axis of the image capture unit 16 independently of the orientation of the obstacle detection unit 18 about each rotation axis of the obstacle detection unit 18.

For example, the support device 14 is configured to enable orientation of the image capture unit 16 about three distinct rotation axes, with the three rotation axes being perpendicular to each other. This enables the field of vision CV of the image capture unit 16 to be oriented in any direction within the angular range of rotation of the image capture unit 16 about each rotation axis thereof.

Preferably, the support device 14 is configured to enable the image capture unit 16 to be oriented about a rotation axis parallel to the pitch axis of the drone 10.

For example, the support device 14 is configured to enable orientation of the obstacle detection unit 18 about a single rotation axis.

Preferably, the detection axis AD is perpendicular to the single rotation axis of the obstacle detection unit 18.

Preferably, the single rotation axis of the obstacle detection unit 18 relative to the drone 10 is parallel to the pitch axis of the drone 10.

In a particular example embodiment, the support device 14 is configured to enable the image capture unit 16 and the obstacle detection unit 18 to rotate about a same common rotation axis.

The common rotation axis is preferably parallel to the pitch axis of the drone 10 when the support device 14 is mounted on the drone 10.

The common rotation axis is for example the single rotation axis of the obstacle detection unit 18 relative to the drone 10.

Preferably, the support device 14 is configured such that the image capture unit 16 and the obstacle detection unit 18 are independently rotatable relative to each other about the common rotation axis.

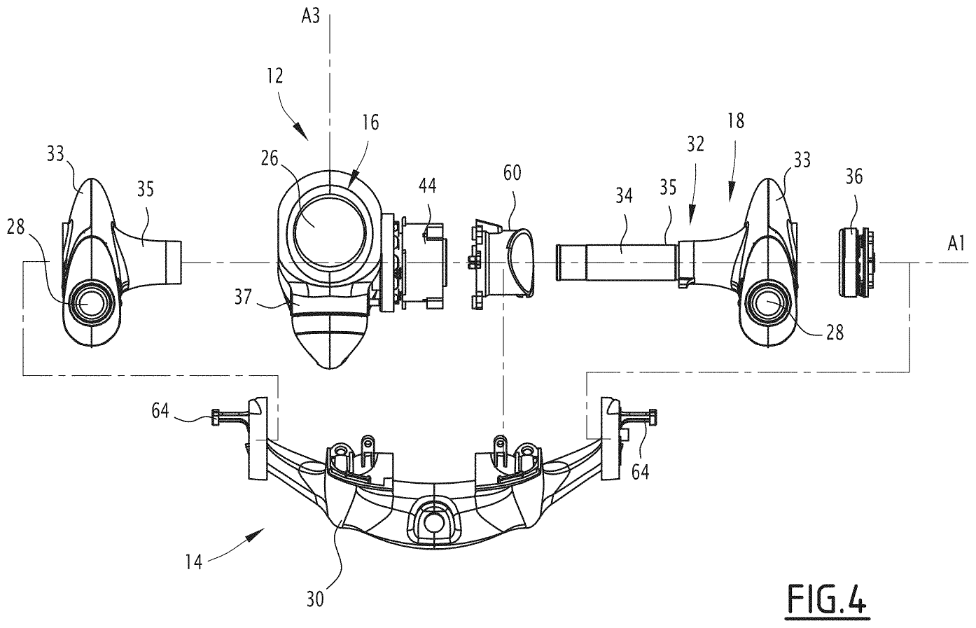

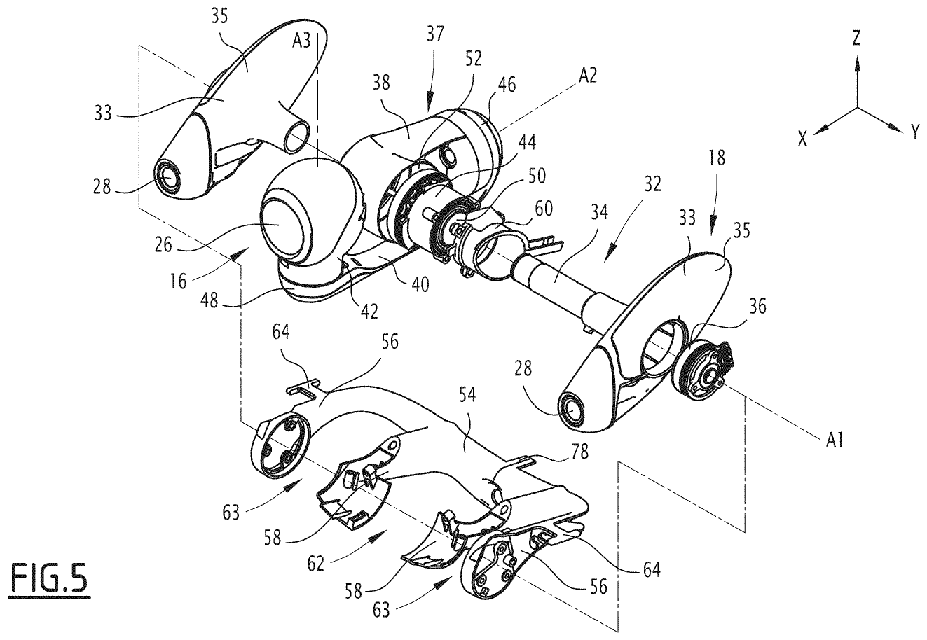

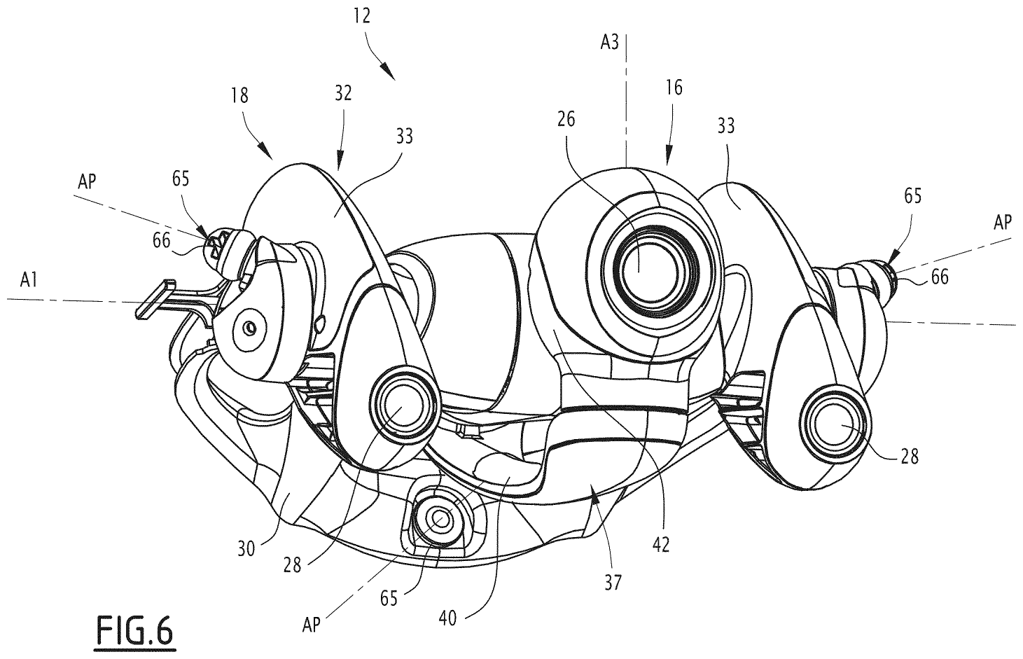

As illustrated in FIGS. 4 and 5, in a particular example embodiment, the support device 14 is configured to enable orientation of the obstacle detection unit 18 only about a first rotation axis A1 that is parallel to the pitch axis of the drone 10, and to enable orientation of the image capture unit 16 about the first rotation axis A1, a second rotation axis A2, and a third rotation axis A3 that are perpendicular to each other.

In one example embodiment, when the drone 10 is landed on a horizontal surface or hovering and the image capture unit 16 is oriented horizontally forward (i.e., pointing parallel to the roll axis of the drone 10), then the second rotation axis A2 is parallel to the roll axis of the drone 10 and the third rotation axis A3 is parallel to the yaw axis of the drone 10.

The support device 14 comprises a mounting piece 30 configured to be mounted to the drone 10.

The support device 14 comprises a support member 32 mounted to the mounting piece 30 to be rotatable about the first rotational axis A1 relative to the mounting piece 30, the support member 32 carrying the obstacle detection unit 18, such that rotation of the support member 32 about the first rotational axis A1 enables the obstacle detection unit 18 to be oriented about the first rotational axis A1.

The detection sensors 28 are arranged on the support member 32 spaced apart from each other along the first rotation axis A1.

The detection axis AD is perpendicular to the first rotation axis A1.

Each detection sensor 28 is oriented along a sensor axis perpendicular to the first rotation axis A1.

Advantageously, the support member 32 comprises two support parts 33 spaced along the first rotation axis A1, each support part 33 carrying a respective detection sensor 28, the two support parts 33 being connected by an intermediate part 34 extending between the two support parts 33.

In one example embodiment, the support member 32 is made of two separate support pieces 35 joined together, each support piece 35 integrating a respective support part 33. The intermediate part 34 is, for example, integrated with one of the two support pieces 35, and configured to be rigidly attached to the other support piece 35.

The support device 14 comprises a detection actuator 36 arranged to control the orientation of the obstacle detection unit 18 about the first rotation axis A1. The detection actuator 36 is an electric motor, for example.

The support device 14 comprises an articulated bracket 37 mounted on the mounting piece 30, the articulated bracket 37 carrying the image capture unit 16 enabling the orientation of the image capture unit 16 relative to the mounting piece 30 about the first rotation axis A1, the second rotation axis A2 and the third rotation axis A3.

The articulated bracket 37 comprises a first segment 38 that is orientable about the first rotation axis A1, a second segment 40 articulated on the first segment 38 so as to be orientable about the second rotation axis A2 relative to the first segment 38, and a third segment 42 articulated on the second segment 40 so as to be orientable about the third rotation axis A3 relative to the second segment 40, with the image capture unit 16 being carried by the third segment 42.

The articulated bracket 37 comprises a first capture actuator 44 for controlling the orientation of the first segment 38 about the first rotational axis A1, a second capture actuator 46 arranged between the first segment 38 and the second segment 40 for controlling the orientation of the second segment 40 about the second rotational axis A2, and a third capture actuator 48 arranged between the second segment 40 and the third segment 42 for controlling the orientation of the third segment 42 about the third rotational axis A3.

The image capture unit 16 is located along the first rotation axis A1 between the sensors 28 of the obstacle detection unit 18.

To do so, the support member 32 extends through an aperture 50 in the articulated bracket 37, the aperture 50 extending along the first rotation axis A1. Thus, the articulated bracket 37 can pivot about the first rotation axis A1 by rotating about the support member 32 without interfering with the support member 32. More particularly, the two support parts 33 are located on opposite sides of the articulated bracket 37, with the intermediate part 34 extending through the aperture 50.

In one example embodiment, the first capture actuator 44 has an annular shape and defines the aperture 50 through which the support member 32 extends. The first segment 38 is carried by the first capture actuator 44, with the first capture actuator 44 itself being carried by the mounting piece 30.

In one example embodiment, the first segment 38 has a receiving recess 52 extending through the first segment 38 and receiving the first capture actuator 44. The intermediate part 34 of the support member 32 extends through the receiving recess 52.

The embodiment of the two-piece support member 32 enables the two support members 35 to be joined together through the hole 50, by inserting the intermediate part 34 into the aperture 50 to join the two support members 35 together.

The mounting piece 30 is configured to support the support member 32 and the articulated bracket 37, while enabling movements of the image capture unit 16 and the obstacle detection unit 18 permitted by the support device 14. The mounting piece 30 comprises a base 54, for example, from which two side arms 56 extend, spaced along the first rotation axis A1 and carrying the support member 32.

The support member 32 extends between the two side arms 56. The support member 32 is hinged at its axial ends to the side arms 56, each axial end being rotatably mounted about the first rotation axis A1 to a respective side arm 56. The sensing actuator 36 is carried by one of the side arms 56, for example.

The mounting piece 30 comprises at least one intermediate arm 58, each intermediate arm 58 extending from the base 54 by being located between the side arms 56.

The articulated bracket 37 is mounted to an intermediate arm 58. More specifically, a fixed part of the first sensor actuator 44 is attached to this intermediate arm 58.

Generally, preferably, the articulated bracket 37 is carried directly by the mounting piece 30, without passing through the support member 32.

Mounting the articulated bracket 37 to the mounting piece 30 is accomplished, for example, via an attachment sleeve 60, with the stationary part of the first capture actuator 44 attached to the attachment sleeve 60, with the aperture 50 aligned with the attachment sleeve 60, with the intermediate part 34 of the support member 32 extending through the aperture 50 and the attachment sleeve 60.

As in the illustrated example, when the mounting piece 30 has side arms 56 and at least one intermediate arm 58, the attachment sleeve 60 is attached to an intermediate arm 58 of the mounting piece 30, for example.

Advantageously, the articulated bracket 37 is configured to carry the image capture unit 16 in a cantilevered fashion at the front of the drone 10. Thus, the image capture unit 16 can be oriented in the horizontal plane limiting the risk of obstruction of the field of vision CV of the image capture unit 16 by the drone 10. In the illustrated example embodiment, the second support segment 40 is elongated to carry the image capture unit in a cantilevered fashion in front of the drone 10.

The mounting piece 30 comprises two intermediate arms 58, for example, located between the two side arms 56.

The side arms 56 and the intermediate arms 58 define receiving spaces between them, in which the image capture unit 16 and the support parts 33 carrying the detection sensors 28 of the obstacle detection unit 18 are received.

More particularly, the intermediate arms 58 define a central receiving space 62 between them, enabling the movements of the image capture unit 16, in particular the rotational movement about the first rotational axis A1, and each lateral arm 56 defines with an adjacent second support arm 58 a lateral receiving space 63 enabling the rotation of a support part 33 about the first rotational axis A1.

The mounting piece 30 has connecting elements 64 for mounting the mounting part to the drone 10. The connecting elements 64 are provided to prevent the mounting piece 30 from being pulled off the drone 10, for example. Each connecting element 64 here has a T-shape, and is intended to fit into a complementarily shaped notch located on the drone 10. The mounting piece 30 here has two connecting elements 64 located on the side arms 56, each located on a respective side arm 56.

The mounting piece 30 is provided with damper attachment assemblies 65 provided for attaching the mounting piece 30 to the drone 10, damping vibrations between the mounting piece 30 and the drone 10 when the mounting piece 30 is mounted on the drone 10. Each damper attachment assembly 65 is attached to the mounting piece 30 and comprises a damper 66 adapted to abut an associated bearing surface of the drone 10 along a bearing axis AP.

The damper 66 of each damper attachment assembly 65 is made of an elastomeric material, for example.

Each damper 66 has a hemispherical shape, for example, the axis of which is the bearing axis AP of the damper 66.

Advantageously, the support axes AP of the damper 66 of the damper attachment assemblies 65 are inclined in relation to each other.

Preferably, the support axes AP intersect each other substantially at the center of gravity of the capture and obstacle detection assembly 12.

Preferably, the mounting piece 30 comprises at least three damper attachment assemblies 65 whose dampers 66 have support axes AP that are not parallel to a common plane.

For example, the mounting piece 30 has exactly three damper attachment assemblies 65 defining three bearing points of the mounting piece 30 on the drone 10.

During operation, the drone 10 generates vibrations. The damper attachment assemblies 65 limit the transmission of vibrations from the drone 10 to the mounting piece 30 and enable limiting the vibrations transmitted to the image capture unit 16 and the obstacle detection unit 18. This improves the quality of the captured images and limits interference with obstacle detection.

The capture and detection assembly 12 is mounted at a front end of the drone body 22.

This enables the obstacle detection unit 18, which is rotatable about the first rotation axis A1 parallel to the pitch axis Y, to be oriented so that its detection axis AD is oriented forward, backward, upward or downward, with little or no obstruction of the detection field CD of the obstacle detection unit 18 by the drone 10.

Advantageously, the capture and detection assembly 12 is mounted on a front end of the drone body 22, the front part 22A of the drone body 22 being raised in relation to the rest of the drone body 10 when the drone 10 is hovering or landed on a horizontal surface.

Thus, the obstacle detection unit 18 may be rotated about the first rotation axis A1 so as to direct its detection field CD obliquely upward and toward the rear of the drone 10, so that the detection field CD at least partially comprises the area behind the drone 10.

Preferably, when the obstacle detection unit 18 is oriented about the first rotation axis A1 such that its detection field CD is directed rearward, each sensor 28 is located above the body of the drone 10.

Advantageously, as illustrated in FIG. 2, each obstacle sensor 28 is located radially away from the first rotation axis A1.

Thus, as the obstacle detection unit 18 rotates about the first rotation axis A1, each detection sensor 28 moves along an arc located in a plane perpendicular to the first rotation axis A1 and centered on the first rotation axis A1. This facilitates the positioning of each detection sensor 28 above the drone 10 when the obstacle detection unit 18 is oriented rearward.

Each obstacle sensor 28 is oriented along a sensor axis perpendicular to the first rotation axis A1 and located away from the first rotation axis A1 so that when the first rotation axis A1 is horizontal, the obstacle detection unit 16 is rotatable about the first rotational axis A1 to a first position in which each obstacle sensor 28 is oriented horizontally in a first direction, being located lower than the first rotational axis A1, and a second position in which each obstacle sensor 28 is oriented horizontally in a second direction opposite to the first direction, being located higher than the first rotational axis A1.

In particular, when the obstacle detection unit 16 comprises at least two obstacle sensors 28 oriented along sensor axes parallel to each other (and to the detection axis AD), in the first position the sensor axes are located in a horizontal plane passing below the first rotation axis A1, and in the second position the sensor axes are located in a horizontal plane passing above the first rotation axis A1.

Preferably, when the obstacle detection unit 18 is oriented horizontally forward (i.e., the detection axis AD and the detection field CD are directed horizontally forward), each obstacle sensor 28 is oriented horizontally by being located lower than the first rotation axis A1.

Thus, when the obstacle detection unit 18 is rotated about the first rotational axis A1 to be oriented horizontally rearward (i.e., a rotation of approximately 180° about the first rotational axis A1 so that the detection axis AD and the detection field CD are directed rearward), each obstacle sensor 28 is oriented horizontally rearward by being located higher than the first rotational axis A1.

This enables the obstacle sensors 28 to be positioned higher when facing rearward, and maximizes rearward detection.

As illustrated in FIG. 2, when viewed along the first rotation axis A1, the detection field CD of the obstacle detection unit 18 scans a detection angular sector SA bounded between two straight lines D1, D2, without being obstructed by the drone body 22.

The angular detection sector SA scanned by the obstacle detection unit 18 around the first rotation axis A1 comprises an area located under the drone 10, an area located in front of the drone, and an area located above the drone 10.

The blind spot of the obstacle detection unit 18 is determined by the drone body 22 itself, which prevents the detection of obstacles in the angular sector complementary to the detection angular sector SA.

The positioning of the obstacle detection unit 18 at a front end of the drone 10 and at a raised position in relation to a rear part 22B of the drone body 22 limits the blind spot.

The drone body 22 having a front part 22A raised relative to a rear part 22B further limits obstruction of the detection field CD of the obstacle detection unit 18 by the drone body 22, particularly when the obstacle detection unit 18 is directed downward or rearward.

Preferably, when viewed along the first rotation axis A1, the angular sector SA scanned by the detection field CD of the obstacle detection unit 18 extends over an angle greater than 180°, in particular an angle greater than 270°.

Furthermore, when the drone 10 moves backwards, the drone 10 tilts backwards, the backwards facing obstacle detection unit 18 points in a direction still close to the horizontal and the obstacle detection unit 18 can detect obstacles backwards, i.e. in the flight direction of the drone 10.

The drone 10 includes an autopilot module 70 configured to fly the drone 10 according to flight instructions from a human pilot or a flight plan sent by a remote-control device, and/or to fly the drone 10 autonomously, in which case the autopilot module 70 itself generates a flight plan according to targets that have been assigned to it, for example.

The drone 10 includes a capture module 72 configured to control the orientation of the image capture unit 16, based on orientation instructions and the position of the drone 10, movements of the drone 10 and/or piloting instructions of the drone 10.

The orientation instructions are received by the drone 10, for example, or calculated by an autopilot of the drone 10 based on a flight plan, for example.

The position and movements of the drone 10 are for example calculated from data provided by a geolocation device of the drone 10 and/or an inertial unit of the drone 10.

The drone 10 includes a detection module 74 configured to control the orientation of the obstacle detection unit 18, based on the movements of the drone 10.

The sensing module 74 is configured to orient the obstacle detection unit 18 relative to the drone 10 such that the obstacle detection unit 18 is oriented substantially in the flight direction DV.

The detection module 74 is, for example, configured to calculate the angle formed between the velocity vector projection of the drone 10 onto the horizontal plane and the projection of the detection axis of the obstacle detection unit 18 onto the horizontal plane, and to modify the orientation of the obstacle detection unit 18 so as to minimize said angle.

As illustrated in FIG. 3, the image capture unit 16 is orientable in a horizontal plane in relation to the drone 10, by rotation about the third axis A3, so as to orient the field of vision CV forward and to the side in relation to the drone 10, in particular to the right or to the left (to the right in FIG. 3).

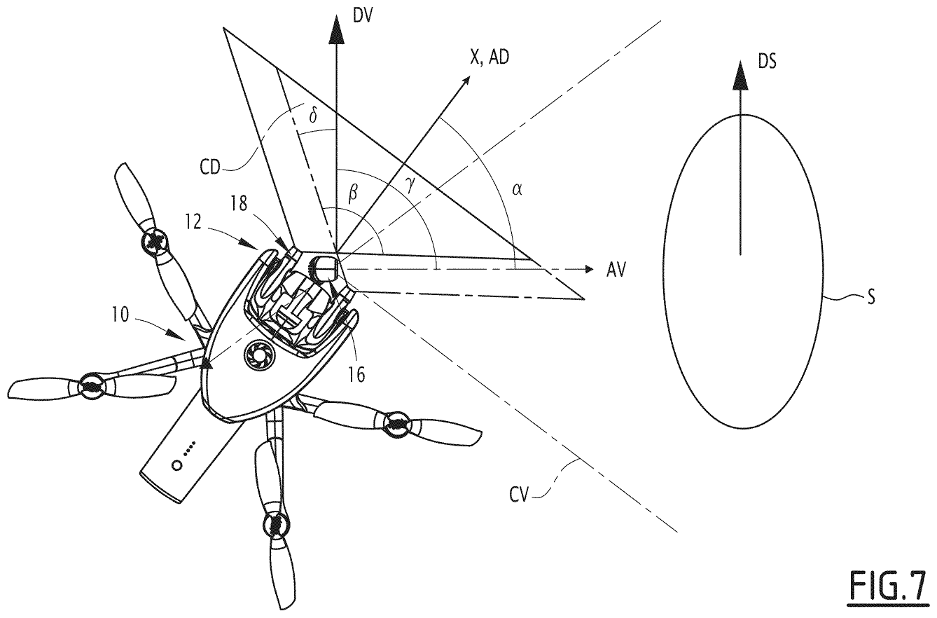

As illustrated in FIG. 7, this enables a mobile subject S to be followed, for example moving along a direction of travel DS, by moving the drone 10 next to the subject S, along a flight direction DV parallel to the direction of travel DS of the subject S (“travelling” function).

The angle between the flight direction DV of the drone 10 and the viewing axis AV of the image capture unit 16 (angle γ in FIG. 7) is named the travelling angle, for example. The angle between the viewing axis AV of the image capture unit 16 and the roll axis X of the drone 10 in the horizontal plane (angle α in FIG. 7) is for example named the yaw angle of the image capture unit 16 in relation to the drone 10.

As illustrated in FIG. 7, depending on the desired travelling angle relative to the subject S and the maximum yaw angle of the image capture unit 16 relative to the drone 10 without obstruction of the field of vision CV of the image capture unit 16 by the drone 10 or by the obstacle detection unit 18, it may be desirable for the drone 10 to fly substantially horizontally with a non-zero angle between the flight direction DV of the drone 10 and the roll axis X of the drone 10 (side-slip flight or “crab” flight).

In such a flight configuration, when the obstacle detection unit 18 is orientable only about the first rotation axis A1 parallel to the pitch axis Y of the drone 10, the detection field CD of the obstacle detection unit 18 is not orientable relative to the drone 10 in the horizontal plane.

Nevertheless, the angular amplitude of the detection field CD in the horizontal plane (angle β in FIG. 7) enables detection of obstacles located in the flight direction DV, even if the flight direction DV makes a non-zero angle with the roll axis X of the drone 10.

Preferably, the autopilot module 70 is configured for piloting the drone 10 so that the flight direction DV remains included in the detection field CD of the obstacle detection unit 18 at all times, in particular in the horizontal plane.

In particular, the autopilot module 70 is configured for piloting the drone 10 such that in a side-slip flight configuration (a non-zero angle between the flight direction and the roll axis of the drone 10), the flight direction DV remains included in the detection field CD of the obstacle detection unit 18 at all times, in particular in the horizontal plane.

Preferably, the autopilot unit 70 is configured for piloting the drone 10 in such a way as to maintain a non-zero angular margin δ at all times between the flight direction DV of the drone 10 and the edges of the detection field CD, in particular in the horizontal plane.

The angular margin δ is 10° or more in the horizontal plane for example, and preferably 20° or more in the horizontal plane. In a particular example embodiment, it is 20°.

The maximum travelling angle γ achievable without obstruction of the field of vision CV while maintaining the angular margin δ depends on the maximum yaw angle of the image capture unit 16 relative to the drone 10 without obstruction and the angular amplitude of the detection field CD in the horizontal plane (angle β in FIG. 7).

More specifically, the maximum attainable travelling angle γ without obstruction of the field of vision CV attributable to another drone component is equal to the sum of the maximum yaw angle of the image capture unit 16 without obstruction and half of the angular amplitude of the detection field CD in the horizontal plane, minus the angular margin δ.

Advantageously, as illustrated in FIG. 7, the capture and detection assembly 12 is configured to be able to achieve a travelling angle equal to or greater than 60°, preferably a travelling angle equal to or greater than 90°, without obstruction of the field of vision CV.

Thus, the drone 10 can move along a flight direction DV by orienting the axis of vision AV of the image capture unit 16 at least up to 60°, in particular at least up to 90°, relative to the flight direction DV, while maintaining the angular margin δ between the flight direction DV and the edges of the detection field CD.

Advantageously, the capture and detection assembly 12 has an active configuration in which the image capture unit 16 is carried in a cantilevered fashion in front of the support device 14, and a rest configuration in which the image capture unit 16 is pivoted about the first rotation axis A1 so as to be brought back to the rear, into a protected space 76 defined between the support device 14 and the drone 10.

The support device 14 comprises a support member 78 located in the protected space 76, for example, to support the image capture unit 16 in a rest configuration, in particular in the absence of power to the actuators of the articulated bracket 37.

In an example embodiment, the drone 10 comprises a safety module 80 configured to detect a situation that may lead to damage to the image capture unit 16, such as impact on the drone 10 and/or a fall of the drone 10, and to command the capture and detection assembly 12 to be placed in a rest configuration. The safety module 80 receives and processes data from an accelerometer and/or an inertial unit of the drone 10 or from the autopilot module 70, for example, to identify a situation requiring safety.

Each of the autopilot module 70, the capture orientation module 72, the detection module 74, and the safety module 80 is implemented as a software application, for example, stored in a memory 82 and executable by a processor 84 of a data processing unit 86 of the drone 10.

In a variant, at least one of the autopilot module 70, the capture orientation module 72, the sensor module 74, and the security module 80 is implemented as a programmable logic component, such as a field programmable gate array (FPGA) or an application specific integrated circuit (ASIC).

FIG. 3 and FIGS. 7 through 11 illustrate flight configurations of the drone 10 in which the image capture unit 16 and the obstacle detection unit 18 are in different orientations relative to the drone 10.

In FIGS. 3 and 7, the drone 10 is stationary or moving forward in a flight direction DV. The obstacle detection unit 18 is oriented about the first rotation axis A1 so as to point forward. The detection field CD covers the area in front of the drone 10. The image capture unit 16 is oriented so as to point obliquely forward and to the side of the drone 10, here to the right. The image capture unit 16 is not oriented along the flight direction DV of the drone 10.

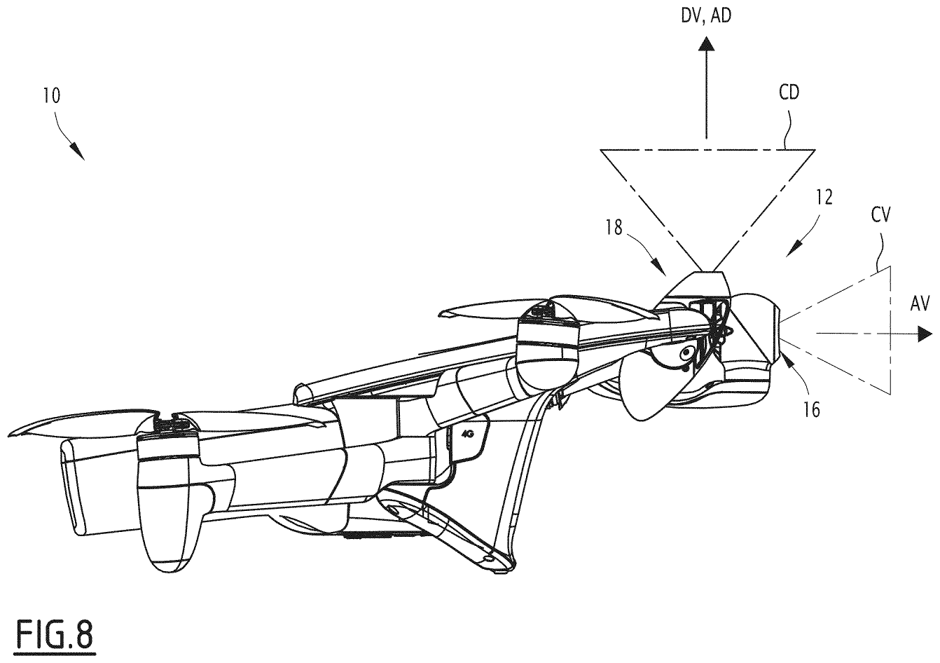

FIG. 8 illustrates a movement of the drone 10 substantially vertically upward along a flight direction DV. This is a take-off situation of the drone 10, for example. The obstacle detection unit is oriented to point upward.

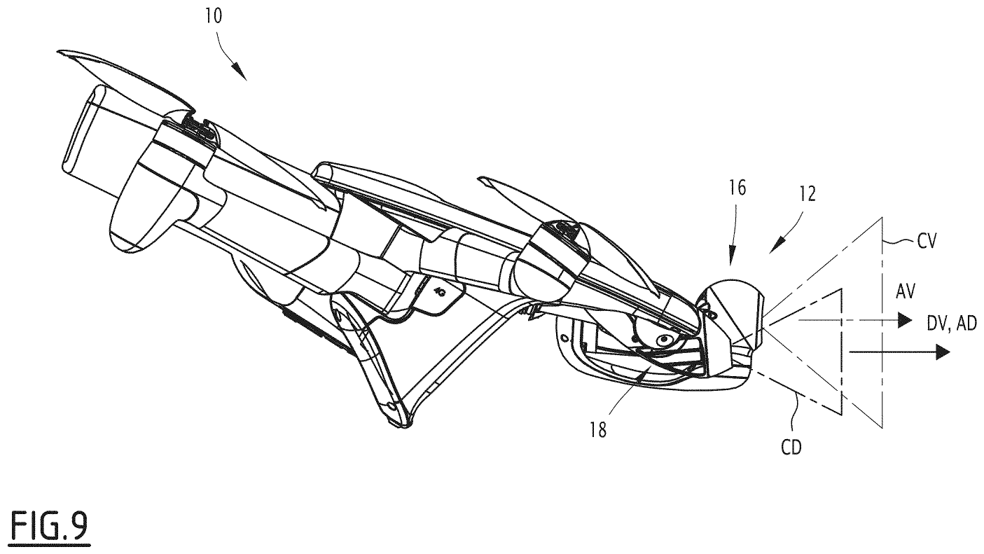

FIG. 9 illustrates a movement of the drone 10 horizontally forward along a flight direction DV. The drone 10 is tilted forward from the horizontal in order to perform this movement. The front part 2A of the drone body 22 is lowered and the rear part 2B of the drone body 22 is raised. The obstacle detection unit 18 is oriented relative to the drone 10 so as to point horizontally forward despite the tilt of the drone 10.

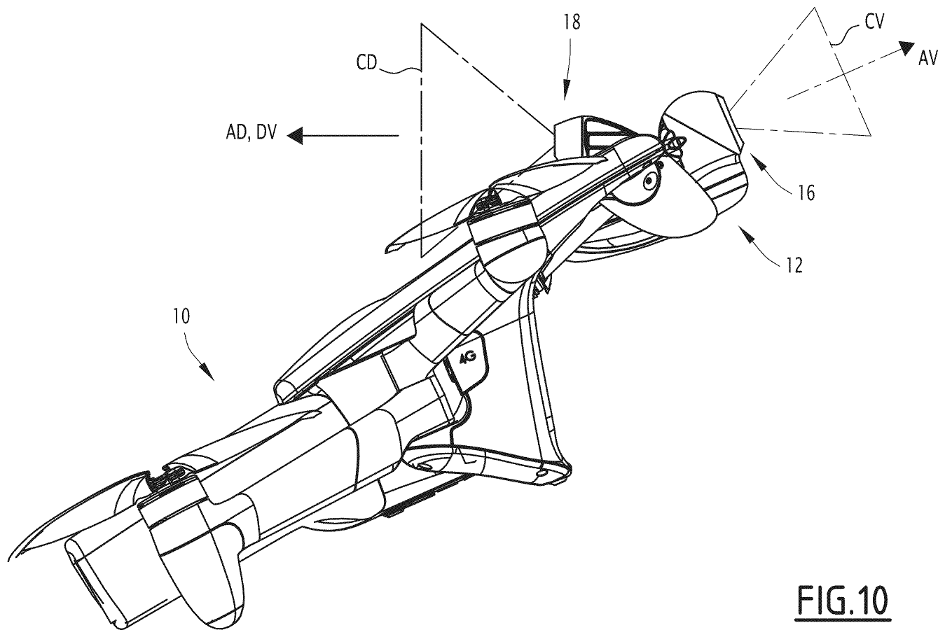

FIG. 10 illustrates a movement of the drone 10 substantially horizontally backwards along a flight direction DV. The drone 10 is tilted backward from the horizontal in order to perform this movement. The front part 22A of the drone body 22 is raised and the rear part 22B of the drone body 22 is lowered. The obstacle detection unit 18 is oriented relative to the drone 10 so as to point above and rearward of the drone 10. Due to the rearward movement of the drone 10, the detection field CD of the obstacle detection unit 18 covers the area behind the drone 10. In FIG. 9, the obstacle detection unit 18 points horizontally backwards.

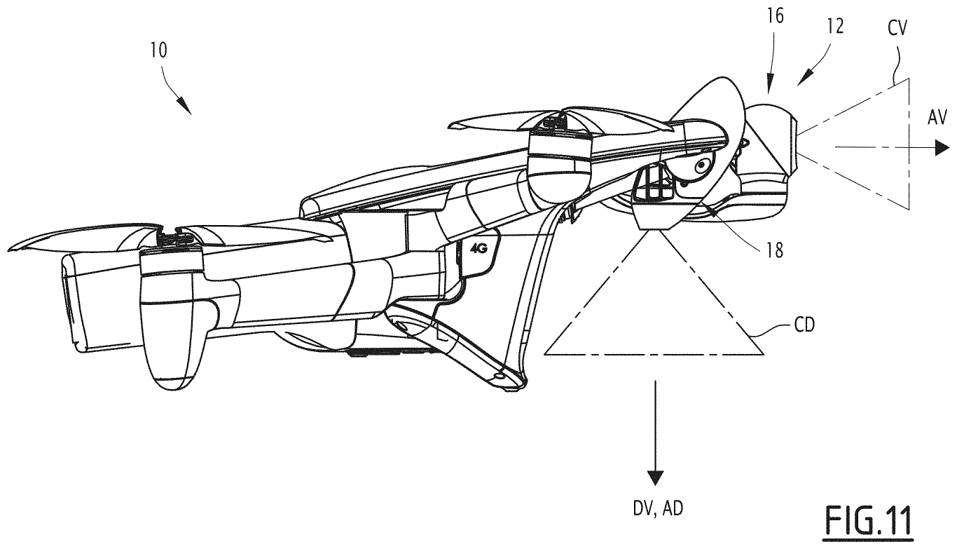

FIG. 11 illustrates a movement of the drone 10 vertically downward along a direction of flight DV, such as when the drone 10 is landing. The drone 10 is substantially horizontal and the obstacle detection unit 18 is oriented to point downward.

The capture and detection assembly 12 comprising an image capture unit 16 and an obstacle detection unit 18 carried by a single support device 14 for mounting on the drone 10 enables capturing images in a desired direction while detecting obstacles that may be in the path of the drone 10.

The provision of a single obstacle detection unit 18 makes it possible to limit the number of components and thus reduce the weight of the drone 10, which is favorable to the flight autonomy of the drone 10.

The positioning of the obstacle detection unit 18 in relation to the image capture unit 16, in particular by mounting the obstacle detection unit 18 and the image capture unit 16 to rotate around the same first rotation axis A1 and/or by positioning the image capture unit 16 between two sensors of the obstacle detection unit 18, makes it possible to avoid the image capture unit 16 obstructing the field of vision of the obstacle detection unit 18.

The positioning of the obstacle detection unit 18 on the drone 10, cantilevered at a front end of the drone 10 raised from the rear part of the drone 10, enables coverage of an extended angular sector with the obstacle detection unit 18, and in particular detection of obstacles under the drone 10, in front of the drone 10, above the drone 10 and partly towards the rear of the drone 10.

Considering that the drone 10 tilts backwards as it moves backwards, the obstacle detection unit 18 in practice is steerable in the flight direction of the drone 10 in all flight configurations of the drone 10.

The support member 32 carrying the obstacle detection unit 18 made of two separate support parts 35 assembled together and each carrying a detection sensor 28, in particular a detection sensor 28 of a stereovision system, enables the support member 32 to be mounted through the aperture 50 of the articulated bracket 37. This technical solution is innovative, insofar as the detection sensors 28 of the obstacle detection systems must be rigorously positioned in relation to each other or in relation to each other. The assembly of the support parts 35 must be done with care. Preferably, the contact surfaces of the support parts 35 are assembled directly on a reference plate in order to ensure coplanarity between them, compatible with the good functioning of the stereovision. The assembly of the parts is done with a strong adhesive, for example, thus delivering a ready-to-use configuration, without the need for post-processing.

It is interesting to note that in the living world, no species evolved by natural selection has used visual sensors around all its body. Some spiders have several simplified eyes around their body, in addition to their main eyes, but this is an exception. Neither insects, nor birds, nor fish, nor mammals, including flying mammals such as bats, have developed an all-around vision system by multiplying visual sensors, even though detection of obstacles or predators in all directions is obviously one of the most important life functions for the survival of the species.

The most common and effective biological solution is a movable head, usually on three axes (left-right (yaw), up-down (pitch) and relative to the horizon (roll)), with a single pair of eyes arranged in a way that is adapted to the animal's behavior: for example, the eyes face forward in primates and laterally in equids. Generally, the eyes are also mobile on two axes (left-right (yaw) and up-down (pitch)). The vision system thus generally comprises a pair of sensors (the eyes) mobile on five axes (the three axes of orientation of the head and the two axes of orientation of the eyes).

Moreover, biological evolution tends towards an economy of means concerning the connection between the eyes and the brain, i.e. the optic nerve. For most living species, the optic nerve is the nerve with the largest diameter, because it transmits the largest amount of information from the whole body of an individual to the brain. It is also a very short nerve. By analogy with a drone, the link between the sensor and the processor requires a very important exchange of information and it is necessary to optimize its length.

Moreover, from an anatomical point of view, we can see that the head of the individual is often well detached from the rest of the body. For flying species (insects, birds, mammals), the head is located in front, which clears the view of the rest of the body, especially the wings. The head enables the eyes to be positioned in such a way as to have an excellent view forward, upward, downward and also to the sides. Turning the head enables most birds to see precisely behind them.

The invention draws on these findings for the design of the capture and detection assembly, its positioning on the drone and the shape of the drone, so that obstacle detection can be performed in a simple and efficient manner, with an economy of means.

The invention is not limited to the examples described above and illustrated above.

For example, in the articulated support 34, the segments are connected in series by being articulated such that the first rotation axis A1 is parallel to the pitch axis, the second rotation axis A2 is parallel to the roll axis, and the third rotation axis A3 is parallel to the yaw axis when the drone 10 is placed on a horizontal surface and the image capture unit 16 is oriented horizontally forward.

In a variant, the second rotation axis A2 may be parallel to the yaw axis and the second rotation axis A2 may be parallel to the roll axis when the drone 10 is landed on a horizontal surface and the image capture unit 16 is oriented horizontally forward.

Generally, the second rotational axis A2 is parallel to one of the roll axis and the yaw axis, with the third rotational axis A3 parallel to the other when the drone 10 is landed on a horizontal surface and the image capture unit 16 is oriented horizontally forward.

The obstacle detection unit 18 is not necessarily a stereovision system. In a variant, it may be a different system for detecting obstacles. The obstacle detection unit 18 may comprise, for example, a stereovision system, a radar system, a light remote detecting system (known as LIDAR for “light detection and ranging” in English), a time of flight camera system (known as TOF for “time of flight” in English), a three-dimensional structured light scene reconstruction system (hereinafter three-dimensional structured light reconstruction system) comprising a structured light projector (checkerboard, bangs, concentric circles, etc.) and a camera, and/or a three-dimensional reconstruction system by analysis of the optical blur on images provided by a camera (hereafter “three-dimensional optical blur analysis system”).

The obstacle detection unit may comprise any combination of these systems. In particular, it may comprise a stereovision system in combination with one or more of a radar system, a light-based remote sensing system, a time-of-flight camera system, a three-dimensional structured light reconstruction system, and a three-dimensional optical blur analysis system.

The capture and detection assembly 12 is not necessarily intended for use on a drone 10. The capture and detection assembly 12 can be used on a vehicle or a robot, for example.

Generally, the capture and detection assembly is operable on a platform, the platform being a drone, a robot, or a vehicle, for example.

1. An image capture and obstacle detection assembly comprising a support device intended to be mounted on a platform, for example, a drone, an image capture unit comprising at least one camera for capturing images and an obstacle detection unit comprising at least one obstacle sensor, the image capture unit and the obstacle detection unit being carried by the support device, the support device being configured such that the image capture unit is rotatable about at least one rotation axis and the obstacle detection unit is rotatable about at least one rotation axis, wherein a rotation axis of the image capture unit and a rotation axis of the obstacle detection unit are coincident and define a common rotation axis, the image capture unit and the obstacle detection unit being rotatable relative to each other about the common rotation axis.

2. The image capture and obstacle detection assembly according to claim 1, wherein the image capture unit is rotatable about three mutually perpendicular rotation axes.

3. The image capture and obstacle detection assembly according to claim 1, wherein the image capture unit comprises a single camera.

4. The image capture and obstacle detection assembly claim 1, wherein the obstacle detection unit is rotatable about a single rotation axis.

5. The obstacle detection assembly according to claim 4, wherein each obstacle sensor is oriented perpendicular to the rotation axis and located at a distance from the rotation axis, such that when the rotation axis is horizontal, the obstacle detection unit is rotatable to a position in which each obstacle sensor is oriented horizontally in one direction with being located lower than the rotation axis and a position in which each obstacle sensor is oriented horizontally in a second direction opposite to the first direction with being located higher than the rotation axis.

6. (canceled)

7. (canceled)

8. (canceled)

9. The image capture and obstacle detection assembly according to claim 1, wherein the obstacle detection unit comprises two obstacle sensors spaced apart along the common rotation axis, the image capture unit being located between the two obstacle sensors.

10. The image capture and obstacle detection assembly according to claim 1, wherein each sensor of the obstacle detection unit is carried by a support member rotatably mounted about the common rotation axis, the image capture unit being rotatable about the common rotation axis by pivoting about the support member.

11. The image capture and obstacle detection assembly according to claim 10, wherein the image capture unit is carried by an articulated bracket having an aperture, the support member extending through the aperture and wherein the articulated bracket comprises an actuator for controlling the orientation of the image capture unit about the common rotation axis, the aperture extending through the actuator.

12. (canceled)

13. The image capture and obstacle detection assembly according to claim 1, wherein the support device is provided with damper attachment assemblies configured to attach the support device to the platform, each attachment assembly comprising a damper provided to abut the platform when the support device is mounted on the platform.

14. (canceled)

15. The image capture and obstacle detection assembly according to claim 13, in which each damper is arranged to abut the platform along a bearing axis, the support device comprising three dampers whose bearing axes are not parallel to the same plane.

16. The image capture and obstacle detection assembly according to claim 1, wherein the support device comprises a mounting piece for mounting the support device, the mounting piece comprising a base and two side arms extending from the base, the obstacle detection uni being disposed between the free ends of the two side arms and carried by the two side arms.

17. The image capture and obstacle detection assembly according to claim 16, wherein the mounting piece comprises at least one intermediate arm, each intermediate arm extending from the base by being located between the two side arms, the image capture unit being carried by each intermediate arm.

18. The image capture and obstacle detection assembly according to claim 17, wherein the image capture unit is mounted to an intermediate arm via a sleeve through which the obstacle detection unit passes.

19. A drone provided with an image capture and obstacle detection assembly according to claim 1, the drone comprising a capture module for controlling the orientation of the image capture unit relative to the drone and a detection module for controlling the orientation of the obstacle detection unit relative to the drone.

20. (canceled)

21. The drone according to claim 19, wherein the image capture unit is rotatable about three mutually perpendicular rotation axes, the other two rotation axes of the image capture unit being parallel to the yaw axis of the drone and the roll axis of the drone, when the drone is hovering or landing on a horizontal surface and the image capture unit is oriented horizontally forward.

22. (canceled)

23. (canceled)

24. (canceled)

25. The drone according to claim 19, wherein the image capture and obstacle detection assembly is mounted at a front end of the drone body at an elevated position relative to a rear part of the drone body, the done body having a front part and a rear part, the front part being elevated relative to the rear part.

26. (canceled)

27. The drone according to claim 19, wherein the sensing module is configured to control the orientation of the obstacle detection unit so as to orient it substantially in the flight direction of the drone.

28. The drone according to claim 19, comprising an autopilot module, the autopilot module and the sensor module being configured to pilot the drone and orient the obstacle detection unit so as to maintain the direction of flight of the drone within the detection field of the obstacle detection unit with a non-zero angular margin between the direction of flight and the edges of the detection field.
